(19) United States
(12) Patent Application Publication
(10) Pub. No.: US 2007/0202154 A1
(43) Pub. Date: Aug. 30, 2007

(54) Process for promoting overall health of an animal

(75) Inventors: Eric Karl Altom, Eaton, OH (US); Thomas William-Maxwell Boileau, Plymouth, MN (US); Elizabeth Anne Flickinger, Dayton, OH (US); John Dean Nizio, Valdosta, GA (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Iams Company and Southeastern Reduction Company, Cincinnati, OH (US)

(21) Appl. No.: 11/710,826

(22) Filed: Feb. 26, 2007

Related U.S. Application Data
(60) Provisional application No. 60/776,981, filed on Feb. 27, 2006.

(51) Int. Cl. A23K 1/165

(52) U.S. Cl. 424/442

(57) ABSTRACT

The process of the present invention comprises an animal food composition that is fed to animals and is pro-nutritional, and is convenient to the pet owner. When the pet owner feeds the animal food composition to the animal, the ingested composition promotes a healthy body weight in the animal and is palatable to the animal, provides a highly effective nutritional aid, promotes a means for controlling fecal hair excretion, controlling oral hair excretion, trichobezoar formation, and satiety in an animal. The animal food composition contains a nut shell.

### CROSS REFERENCE TO RELATED APPLICATIONS

This application claims the benefit of U.S. Provisional Application No. 60/776,981 filed on Feb. 27, 2006.

### FIELD OF THE INVENTION

The present invention relates a process for controlling fecal hair excretion, controlling oral hair excretion and trichobezoar formation in an animal comprising; feeding an animal an animal food composition comprising a nut shell. The invention further relates to a process for promoting satiety in an animal and process for promoting healthy body weight in an animal.

### BACKGROUND OF THE INVENTION

Hairballs (trichobezoar) can be prevalent in some animals, such as cats and rabbits, because of natural grooming habits. Hairballs result upon consumption of hair by an animal. This typically occurs as a result of dermatitis or the animal grooming itself or a companion animal. Because of the natural grooming behavior of some animals, such as dog, cat, rabbit, guinea pig, hamster, gerbil, ferret, horses, zoo mammal, hairballs are quite prevalent therein.

Not surprisingly, animals with lengthy coats are more predisposed to hairballs. However, hairballs can manifest themselves in animals having any length of hair.

Studies have shown that cats normally may spend as much as one-third of their waking hours cleaning and grooming themselves. Increased hair loss may occur as a result of disease (e.g., neuroses, excessive grooming, and dermatological related conditions) and because of normal seasonal fluctuations (molting) that may increase in the summer and decrease in the winter compared to spring or fall. (Hendricks, Protein metabolism in the adult domestic cat (Felis Catus), Ph.D. Thesis, Massey University, Palmerston North, New Zealand, 1996.)

Common physiological consequences of hairballs include diarrhea, vomiting, constipation and other difficulties if the hairball becomes lodged in the mammal's lower bowel. Such obstructions can become life-threatening and require surgical intervention. The cat may attempt to eliminate the hairball from the stomach through the vomiting reflex.

Conventional materials and methods for treating and preventing hairballs include the administration of lubricants (e.g., petroleum jelly or mineral oil), or pineapple juice (see, for example, U.S. Pat. No. 6,080,403). An alternate strategy that has been attempted to control the formation and occurrence of hairballs involves the use of diets or dietary supplements which include high levels of supplemental indigestible (non-fermentable) fiber such as cellulose to increase the passage of hair through the gastrointestinal tract and into the feces without causing blockage or constipation. However, such diets may decrease stool quality, cause diarrhea, and otherwise do not promote gastrointestinal health. Also it has been observed in cats fed large amounts of insoluble fiber source additional side effects, such as constipation, excessive stool output, decreased nutrient digestibility, and inferior haircoat appearance. However, these methods may be limited in their effectiveness, convenience, or by their associated side effects.

Many mammals, including dogs and cats, possess an inability to adequately regulate their body weight, as is evidenced by the rising incidence of obesity. This may be due to a number of factors, including impaired satiety signaling. When satiety is reduced, food intake increases, which may contribute to excess weight gain and obesity.

Additionally, conventional dietary approaches and pharmaceutical approaches to inducing satiety include feeding diets that are extremely low in caloric density, feeding fermentable fibers to improve glucose homeostasis, intervention to ameliorate appetite, and feeding gelling fibers to delay gastric emptying. However, these diets and pharmaceutical approaches may result in poor palatability, excessive fecal output, and inferior haircoat appearance, high levels of fermentable fiber may result in formation of loose and (or) watery stools, while diets containing a high level of gelling fibers may result in nausea, vomiting, and (or) formation of loose stools.

There still exists a need for treatments and aids, i.e., which are pro-nutritional, promote gastrointestinal health, are convenient to the pet owner and promotes a healthy body weight in an animal and overall health of an animal.

It is therefore an object of the present invention to provide a process that comprises feeding an animal an animal food composition that is both palatable to an animal, provides a highly effective nutritional aid and promotes a means for controlling fecal hair excretion, controlling oral hair excretion, trichobezoar formation, satiety in an animal and promotes a healthy body weight.

### SUMMARY OF THE INVENTION

The present invention relates to a process for controlling fecal hair excretion, controlling oral hair excretion and trichobezoar formation in an animal comprising; feeding an animal an animal food composition comprising a nut shell.

The present invention further relates to a process for promoting satiety in an animal comprising; feeding an animal an animal food composition comprising a nut shell.

The present invention further relates to a process for promoting healthy body weight in an animal comprising; feeding an animal an animal food composition comprising a nut shell.

### DETAILED DESCRIPTION OF THE INVENTION

The process for controlling fecal hair excretion, controlling oral hair excretion and trichobezoar formation in an animal comprising; feeding an animal an animal food composition comprising a nut shell.

These and other limitations of the compositions and methods of the present invention, as well as many of the optional ingredients suitable for use herein, are described in detail hereinafter.

As used herein, the term “adapted for use” means that the animal food products described can meet the American Association of Feed Control Officials (AAFCO) safety requirements for providing animal food products for an animal as may be amended from time to time.

As used herein, the term “animal” means an animal preferably including (for example) dogs, cats, horses, rabbits, guinea pig, hamster, gerbil, ferret, zoo mammals and the like. Dogs, rabbits, horses and cats are particularly preferred.

As used herein, the term “animal food composition” means a composition that can be ingested by an animal, supplements for a animal, pet food, dog food, cat food, treats, biscuits, raw hide, treats, chews, fillers, gravy, sauce, beverage, supplemental water, and combinations thereof. The animal food composition can be wet, moist, and/or dry.

The term “complete and nutritionally balanced” as used herein, unless otherwise specified, refers to an animal food product having all known required nutrients in proper amounts and proportions based upon the recommendation of recognized authorities in the field of animal nutrition.

The term “nut” as used herein, unless otherwise specified, refers to a fruit with at least about one seed, at least about 2 seeds, in which the ovary wall or a portion of the ovary wall becomes hard at maturity. The term “hard” as used herein means stony or woody.

The term “nut shell” as used herein, unless otherwise specified, refers to a hard dense fibrous layer that surrounds both a seed and a fruit; preferably said seed and fruit is a “nut”. Nut shell is typically procured from a company engaged in the business of separating the nut shell from the nut meat. This company may be referred to as a commercial cracking facility. Several items may be found when procuring nut shell from a cracking facility. This would include the hard nut shell, the soft inner membrane known as “packing tissue”, and any residual nut meats that may have not been removed. The term “packing tissue” as used herein, refers to the lower density soft and or flexible material that immediately surrounds the nut meat and may divide the nut meat into halves or distinct sections. This packing tissue may be darker in color than a cross section of the hard nut shell. The packing tissue may be present with the nut shell but preferably the packing tissue is not present with the nut shell. For example, examination of pecan nut shell as procured from a commercial cracking facility may show the following variation by weight of items:

| | |
|---|---|
| Hard nut shell | 55-80% |
| Packing tissue | 10-30% |
| Pecan nut meat | <1-15% |

The term “satiety” as used herein, unless otherwise specified, means a sense of fullness, the lack of a desire to eat, or the absence of hunger or the reduction in voluntary food intake.

All percentages, parts and ratios as used herein are by weight of the total product, unless otherwise specified. All such weights as they pertain to listed ingredients are based on the active level and, therefore do not include solvents or by-products that may be included in commercially available materials, unless otherwise specified.

The processes, animal food composition and methods of the present invention can comprise, consist of, or consist essentially of, the essential elements and limitations of the invention described herein, as well as any additional or optional ingredients, components, or limitations described herein or otherwise useful in animal food compositions intended for animal consumption.

Product Form

The animal food composition of the present invention are preferably administered to control fecal hair excretion, control oral hair excretion, prevent trichobezoar formation, promote satiety in an animal, and promote healthy body weight in an animal.

The animal food composition of the present invention can be a moist animal food composition (i.e. those having a total moisture content of from about 16% to 50%, by weight of the product), and/or a wet animal food composition (i.e. those having a total moisture content of greater than 50%, by weight of the product), and/or dry animal food composition (i.e. those having a total moisture content of from about 0% to about 16%, by weight of the product). Unless otherwise described herein, wet animal food composition, moist animal food composition and/ or dry animal food composition are not limited by their composition or method of preparation.

The animal food composition herein can be complete and nutritionally balanced. A complete and nutritionally balanced animal food composition may be compounded to be fed as the sole ration and is capable of maintaining the life and/or promote reproduction without any additional substance being consumed, except for water.

The animal food composition and components of the present invention are selected for consumption by an animal and are not intended for consumption by humans. Non-limiting examples of animal food compositions include supplements for an animal, pet food, dog food, cat food, treats, biscuits, raw hide, treats, chews, fillers gravy, sauce, beverage, supplemental water, and combinations thereof.

Additionally, administration in accordance with the present invention may be continuous or intermittent, depending, for example, upon the recipient's physiological condition, whether the purpose of the administration is therapeutic or prophylactic, and other factors known to skilled practitioners.

Nut Shell

The processes of the present invention comprise feeding an animal an animal food composition that comprises a nut shell. The use of nut shell has proved to be beneficial for promoting a means for controlling fecal hair excretion, controlling oral hair excretion, trichobezoar formation, and satiety in an animal. It is believed that the nut shell aids in the gastric and intestinal passage of ingested hair and their subsequent excretion in the feces of an animal. Without being bound by theory, it is believed that the nut shells and supplemental fibers of the current invention trap or bind ingested hair, increase gastric emptying and allow the ingested hair to pass out through the feces more frequently. The increased rate of passage is believed to decrease the accumulation of hair in the stomach and the chronic formation of hairballs.

The nut shell contains a unique blend of nutrients that promote satiety and maintenance of a healthy body weight. The nut shell is low in calories, rich in insoluble fiber and lignans, and contains a high proportion of branched-chain amino acids in relation to total protein. It is believed that the intake of nut shell enhances satiety signaling through several mechanisms, including reducing food energy density, increasing gastric distention, mitigating sharp rises and falls in blood glucose, and promoting hormonal satiety signals.

The animal food composition comprises a nut shell. The nut shell has a specific gravity from about 1.0 g/cc to about 4.0 g/cc, from about 1.1 g/cc to about 3.0 g/cc, from about 1.2 g/cc to about 2.0 g/cc, from about 1.3 g/cc to about 1.9 g/cc, and from about 1.4 g/cc to about 1.8 g/cc as measured using Association of Official Analytical Chemists (AOAC) (volume 17) method 945.06.

The nut shell has a pH of from about 4.0 to about 7.0, from about 4.5 to about 6.5, from about 5.0 to about 6.0, and from about 5.2 to about 5.8 measured at 20° C. using AOAC (volume 17) method 943.02.

The nut shell of the present invention has moisture content. The nut shell has a moisture content of from about 0% to about 20%, from about 0.5% to about 15%, from about 1% to about 12%, from about 2% to about 10%, from about 3% to about 9%, from about 4% to about 8%, and from about 5% to about 7% as measured by AOAC (volume 17) method 925.09.

The nut shell is selected from the group consisting of pecan nut shell, walnut nut shell, filbert nut shell, hickory nut shell, hazelnut shell, chestnut nut shell, and combinations thereof.

The animal food composition comprising on a dry matter basis from about 0.01% of said nut shell to about 100% of said nut shell, by weight of the composition. The animal food composition comprising on a dry matter basis from about 0.05% of said nut shell to about 50% of said nut shell, from about 0.1% of said nut shell to about 30% of said nut shell, from about 0.2% of said nut shell to about 20% of said nut shell, from about 0.5% of said nut shell to about 10% of said nut shell, by weight of the composition.

When the nut shell is pecan nut shell, the pecan nut shell is present on a dry matter basis, from about 0.01% of said pecan nut shell to about 100% of said pecan nut shell, from about 0.05% of said pecan nut shell to about 50% of said pecan nut shell, from about 0.1% of said pecan nut shell to about 30% of said pecan nut shell, from about 0.2% of said pecan nut shell to about 20% of said pecan nut shell, from about 0.5% of said pecan nut shell to about 10% of said pecan nut shell, by weight of the composition.

The nut shell of the present invention may comprise packing tissue. The nut shell of the present invention may comprise packing tissue. When present, the packing tissue level is from about 0% to about 30%, preferably from about 0.01% to about 20%, preferably from about 0.05% to about 15%, preferably from about 0.1% to about 10%, by weight of the composition.

The nut shell utilized in accordance with the present invention can additionally be formulated as a pharmaceutical, and/or veterinary composition and administered to an animal in a variety of forms adapted to a chosen route of administration, for example, orally, parenterally, intravenously, subcutaneously, and like routes. A preferred method of administration is oral administration.

Supplemental Fiber

The animal food composition of the present invention can comprise a supplemental fiber. The inclusion of supplemental fibers that are fermentable by the intestinal microflora provide short-chain fatty acids and lactate that promote intestinal health and favorably modulate intestinal bacterial populations.

The supplemental fiber source is selected from the group consisting of fermentable fiber, poorly-fermentable fiber, and combinations thereof.

When present, the animal food composition comprises on a dry matter basis, from about 0.05% supplemental fiber source to about 99% supplemental fiber source, from about 0.1% supplemental fiber source to about 80% supplemental fiber source, from about 2% supplemental fiber source to about 70% supplemental fiber source, from about 3% supplemental fiber source to about 50% supplemental fiber source, from about 4% supplemental fiber source to about 40% supplemental fiber source, from about 5% supplemental fiber source to about 20% supplemental fiber source, by weight of the composition.

The fermentable fibers can be used display certain organic matter disappearance percentages. The fermentable fibers will have an organic matter disappearance (OMD) of: from about 10 to about 100 percent when fermented by fecal bacteria in vitro for a 24 hour period. That is, from about 10 to about 100 percent of the total organic matter originally present is fermented and converted by the fecal bacteria. The organic matter disappearance of the fibers is preferably at least 20 percent, and most preferably is at least 30 percent.

Thus, in vitro OMD percentage may be calculated as follows:
{1−[(OM residue−OM blank)\OM initial]}×100,
where OM residue is the organic matter recovered after 24 hours of fermentation, OM blank is the organic matter recovered in corresponding blank tubes (i.e., tubes containing medium and diluted feces, but no substrate), and OM initial is that organic matter placed into the tube prior to fermentation. Additional details of the procedure are found in Sunvold et al, J. Anim. Sci. 1995, vol. 73: 1099-1109.

Fermentable fibers which are useful in the present invention include beet pulp, carob bean, psyllium, citrus pectin, rice bran, locust bean, fructooligosaccharide, inulin, oligofrustose, galactooligosaccharide, citrus pulp, mannanoligosaccharides, arabinogalactan, lactosucrose, glucomannan, lactulose, polydextrose, apple pomace, tomato pomace, carrot pomace, cassia gum, xanthan gum, gum karaya, gum talha, gum arabic, and combinations thereof.

By poorly-fermentable fiber we mean fiber sources which have an organic matter disappearance of less than about 10 percent when fermented by fecal bacteria for a 24 hour period. Poorly-fermentable fibers which are useful in the present invention include cellulose, hemicellulose, cellulose ethers, lignin and combinations thereof.

The use of a supplemental fiber in the present invention may be beneficial for controlling hairballs by increasing the gastric and intestinal passage of ingested hair and their subsequent excretion in the feces of the animal without compromising gastrointestinal health.

Animal Food Compositions

It is believed that the nut shell described in the present invention can be added to any animal food composition adapted for administration to an animal.

Typical formulae for animal food compositions are well known in the art. In addition to proteinaceous and farinaceous materials, the animal food compositions of the invention generally may include vitamins, minerals, and other additives such as flavorings, preservatives, emulsifiers and humectants. The nutritional balance, including the relative proportions of vitamins, minerals, protein, fat and carbohydrate, is determined according to dietary standards known in the veterinary and nutritional art.

Nonlimiting examples of dry animal food compositions may optionally contain on a dry matter basis, from about 1% to about 50% crude protein, from about 0.5% to about 25% crude fat, from about 1% to about 10% supplemental fiber, and from about 1% to about 30% moisture, all by weight of the animal food composition. Alternatively, a dry animal food composition may contain on a dry matter basis, from about 5% to about 35% crude protein, from about 5% to about 25% crude fat, from about 2% to about 8% supplemental fiber, and from about 2% to about 20% moisture, all by weight of the animal food composition. Alternatively, the dry animal food composition contains on a dry matter basis, a minimum protein level of about from about 9.5% to about 22%, a minimum fat level of from about 8% to about 13%, a minimum moisture level of from about 3% to about 8%, a minimum supplemental fiber level of from about 3% to about 7%, all by weight of the animal food composition. The dry animal food composition may also have a minimum metabolizable energy level of about 3.5 Kcal/g.

Nonlimiting examples of a moist animal food composition may optionally contain on a dry matter basis, from about 0.5% to about 50% crude protein, from about 0.5% to about 25% crude fat, from about 0.5% to about 15% supplemental fiber, from about 30% to about 50% moisture, all by weight of the animal food composition. Alternatively, the moist animal food compositions may contain on a dry matter basis, from about 5% to about 35% crude protein, from about 5% to about 25% crude fat, from about 1% to about 5% supplemental fiber, and from about 35% to about 45% moisture, all by weight of the animal food composition. Alternatively, the moist animal food composition may have on a dry mater basis, a minimum protein level of about from about 9.5% to about 22%, a minimum fat level of from about 8% to about 13%, a minimum moisture level of about 38% to about 42%, a minimum supplemental fiber level of from about 2% to about 3%, all by weight of the animal food composition. The moist animal food composition may also have a minimum metabolizable energy level of about 3.5 Kcal/g and from about 0.1% to about 20% ash, and from about 0.001% to about 5.0% taurine.

Nonlimiting examples of a wet animal food composition may optionally contain on a dry matter basis, from about 0.5% to about 50% crude protein, from about 0.5% to about 25% crude fat, from about 0.01% to about 15% supplemental fiber, from about 50% to about 90% moisture, all by weight of the animal food composition. Alternatively, the wet animal food compositions may contain on a dry matter basis, from about 5% to about 35% crude protein, from about 5% to about 25% crude fat, from about 0.05% to about 5% supplemental fiber, and from about 60% to about 85% moisture, all by weight of the animal food composition. Alternatively, a wet animal food composition may contain on a dry matter basis, a minimum protein level of about from about 9.5% to about 22%, a minimum fat level of from about 8% to about 13%, a moisture level of from about 65% to about 80%, a minimum supplemental fiber level of from about 0.1% to about 3%, all by weight of the animal food composition. The wet animal food composition may also have a minimum metabolizable energy level of about 1.0 KcaI/g and from about 0.1% to about 20% ash, and from about 0.001% to about 5.0% taurine.

In one embodiment of the present invention, the animal food composition is an animal food composition, whether dry, moist, wet, or otherwise, that comprises on a dry matter basis, from about 5% to about 50%, alternatively 20% to about 50% of animal-derived ingredients, by weight of the animal food composition. Non-limiting examples of animal-derived ingredients include chicken, beef, pork, lamb, turkey (or other animal) protein or fat, egg, fishmeal, and the like.

Where the animal food composition is in the form of a gravy, the composition may comprise at least 10% of a broth, or stock, non-limiting examples of which include vegetable beef, chicken or ham stock. Typical gravy compositions may comprise on a dry matter basis, from about 0.5% to about 5% crude protein, and from about 2% to about 5% crude fat.

Where the animal food composition is in the form of a supplement composition such as biscuits, chews, and other treats, the supplement may comprise, on a dry matter basis, from about 20% to about 60% protein, from about 22% to about 40% protein, by weight of the supplement composition. As another example, the supplement compositions may comprise, on a dry matter basis, from about 5% to about 35% fat, or from about 10% to about 30% fat, by weight of the supplement composition. Food and supplement compositions intended for use by animals such as cats or dogs are commonly known in the art.

Optional Ingredients

The animal food composition of the present invention can further comprise a wide range of other optional ingredients.

Nonlimiting examples of additional components include animal protein, plant protein, farinaceous matter, vegetables, fruit, egg-based materials, undenatured proteins, food grade polymeric adhesives, gels, polyols, starches, gums, flavorants, seasonings, salts, colorants, time-release compounds, minerals, vitamins, antioxidants, prebiotics, probiotics, aroma modifiers, textured wheat protein, textured soy protein, textured lupin protein, textured vegetable protein, breading, comminuted meat, flour, comminuted pasta, water, and combinations thereof.

Nonlimiting examples of optional ingredients can include at least one vegetable. Nonlimiting examples of vegetables include carrots, peas, potatoes, cabbage, celery, beans, corn, tomatoes, broccoli, cauliflower, leeks and combinations thereof.

Also useful herein, as an optional ingredient, is a filler. The filler can be a solid, a liquid or packed air. The filler can be reversible (for example thermo-reversible including gelatin) and/or irreversible (for example thermo-irreversible including egg white). Nonlimiting examples of the filler include gravy, gel, jelly, aspic, sauce, water, air (for example including nitrogen, carbon dioxide, and atmospheric air), broth, and combinations thereof.

Nonlimiting examples of colorants include, but are not limited to, synthetic or natural colorants, and any combination thereof. When present the colorants are from about 0.0001% to about 5%, more preferably from about 0.001% to about 1%, even more preferably from about 0.005% to about 0.1%, on a dry matter basis, of said colorant.

Additionally, probiotic microorganisms, such as Lactobacillus or Bifidobacterium species, for example, may be added to the composition or the animal food compositions themselves.

Also useful herein, as an optional ingredient, is at least one fruit. Nonlimiting examples include tomatoes, apples, avocado, pears, peaches, cherries, apricots, plums, grapes, oranges, grapefruit, lemons, limes, cranberries, raspberries, blueberries, watermelon, cantelope, mushmellon, honeydew melon, strawberries, banana, and combinations thereof.

The animal food composition may contain other active agents such as long chain fatty acids and zinc. Suitable long chain fatty acids include alpha-linoleic acid, gamma linolenic acid, linoleic acid, eicosapentanoic acid, and docosahexanoic acid. Fish oils are a suitable source of eicosapentanoic acids (EPA) and docosahexanoic acid (DHA). The DHA level is at least about 0.05%, alternatively at least about 0.1%, alternatively at least about 0.15% of the animal food composition, all on a dry matter basis. The EPA level is at least about 0.05%, alternatively at least about 0.1%, alternatively at least about 0.15% of the animal food composition, all on a dry matter basis.

The compositions of the present invention may further comprise a source of carbohydrate. Grains or cereals such as rice, corn, milo, sorghum, barley, wheat, and the like are illustrative sources.

The compositions may also contain other materials such as dried whey and other dairy by products. METHOD OF MANUFACTURE

The animal food composition of the present invention may be prepared by any known or otherwise effective technique, suitable for making and formulating the desired animal food composition. It is effective to manufacture the animal food composition comprising the process of:
(a) receiving a nut shell from a cracking facility;
(b) reducing the particle size of the nut shell to a more storable size;
(c) passing the nut shell through a screening process;
(d) grinding the nut shell via a fine grind using a milling system having an air-classifier; and
(e) incorporating the ground nut shell in the animal food composition.

The animal food composition can be processed by a variety of well-known means including steam tunnel, extrusion, freeze-texturization, baking, gelling, retort, microwave heating and combinations thereof.

Total Moisture Content Method

The method involves the analysis of total moisture content in the animal food composition. The analysis is based on the procedure outlined in AOAC method 930.15 and AACC method 44-19.

An animal food composition sample is prepared by taking one unit volume, for example, 375 gram of the composition, and homogenizing in a food processor to a uniform consistency like a paste. An animal food composition larger than 375 gram would be subdivided to create equal and representative fractions of the whole such that a 375 gram sample is obtained.

The paste of the animal food composition is individually sampled in triplicate at a volume less than or equal to 100 ml and placed individually sealed in a 100 ml Nasco Whirl-Pak® (Fort Atkinson, Wis. 53538-0901). During the process of sealing the Whirl-Pak®, excess air is evacuated manually from the container just prior to final closure thereby minimizing the container headspace. The Whirl-Pak® is closed per manufacturer's instructions—tightly folding the bag over three (3) times and bending the tabs over 180 degrees.

All samples are refrigerated at 6° C. for less than 48 h prior to moisture analysis.

For total moisture analysis, the tare weight of each moisture tin and lid are recorded to 0.0001 g. Moisture tins and lids are handled using dry and clean forceps. Moisture tins and lids are held dry over desiccant in a sealed desiccator. A Whirl-Pak® containing a sample is unfolded and a 2.0000±0.2000 gram sample is weighed into the uncovered moisture tin. The weight of the sample in the moisture tin is recorded. The lid is placed atop the moisture tin in an open position to allow moisture loss but contain all other material during air oven drying. The lid and moisture tin loaded with sample are placed in an air oven operating at 135° C. for 6 h. Time is tracked using a count-down timer.

After drying, the tin is removed from the oven and the dried lid is placed atop the tin using forceps. The covered moisture tin with dried sample is placed immediately in a desiccator to cool. The sealed desiccator is filled below the stage with active desiccant. Once cool to room temperature, the covered moisture tin with dried sample is weighed to 0.0001 g and weight recorded. The total moisture content of each sample is calculated using the following formula:
Total Moisture Content (%)=100−(weight of tin, lid and sample after drying−empty tin and lid weight)×100/initial sample weight.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

### EXAMPLES

The following examples further describe and demonstrate embodiments within the scope of the invention. The examples are given solely for the purpose of illustration and are not to be construed as limitations of the present invention, as many variations thereof are possible without departing from the spirit and scope of the invention.

Dry animal food compositions

| | Percentage % on dry matter basis (w/w) | | | | | | |
|---|---|---|---|---|---|---|---|
| | Ex. 1 | Ex. 2 | Ex. 3 | Ex. 4 | Ex. 5 | Ex. 6 | Ex. 7 |
| Ingredient | | | | | | | |
| Chicken products and | 43.0 | 45.0 | 50.0 | 52.0 | 52.0 | 52.0 | 53.2 |
| meals | | | | | | | |
| Cereal grains | 19.42 | 40.4 | 35.6 | 22.7 | 33.4 | 33.4 | 4.0 |
| Fat | 2.97 | 2.0 | 1.0 | 6.0 | 7.38 | 6.89 | 7.2 |
| Egg product | 2.4 | 1.5 | 3.0 | 2.0 | 2.0 | 2.0 | 2.0 |
| Vitamins | 0.4 | 0.4 | 0.4 | 0.4 | 0.3 | 0.3 | 0.3 |
| Minerals | 1.3 | 1.2 | 1.0 | 1.2 | 1.2 | 1.2 | 1.2 |
| Choline chloride | 0.3 | 0.3 | 0.3 | 0.3 | 0.3 | 0.3 | 0.3 |
| DL-Methionine | 0.2 | 0.2 | 0.1 | 0.1 | 0.1 | 0.1 | 0.1 |
| Supplemental fiber | | | | | | | |
| Beet pulp | 0.0 | 1.0 | 5.4 | 7.0 | 3.0 | 3.0 | 4.0 |
| Fructo-oligosaccharide | 0.0 | 0.0 | 0.1 | 2.3 | 0.3 | 0.3 | 0.0 |
| Nut shell | | | | | | | |
| Pecan nut shell | 0.0 | 0.0 | 3.0 | 5.0 | 0.01 | 0.5 | 25.0 |
| Pecan packing tissue | 0.0 | 0.0 | 0.1 | 1.0 | 0.0 | 0.01 | 2.7 |
| Walnut nut shell | 30.0 | 7.0 | 0.0 | 0.0 | 0.01 | 0.0 | 0.0 |
| Walnut packing tissue | 0.01 | 1.0 | 0.0 | 0.0 | 0.0 | 0.0 | 0.0 |

Wet animal food compositions

| | Percentage on dry matter basis (w/w) | | | | | | | |
|---|---|---|---|---|---|---|---|---|
| | Ex. 8 | Ex. 9 | Ex. 10 | Ex. 11 | Ex. 12 | Ex. 13 | Ex. 14 | Ex. 15 |
| Ingredient | | | | | | | | |
| Poultry and meat products | 88.0 | 60.0 | 88.58 | 2.0 | 39.5 | 24.0 | 28.0 | 18.0 |
| Cereal grains | 6.9 | 27.45 | 0 | 2.0 | 24.0 | 5.5 | 28.5 | 18.0 |
| Egg Product | 2.5 | 5.6 | 1.0 | 0.5 | 0.5 | 2.5 | 3.0 | 0.5 |
| Taurine | 0.1 | 0.1 | 0 | 0.0 | 0.0 | 0.0 | 0.0 | 0.0 |
| Vitamins | 0.04 | 0.1 | 0.1 | 0.25 | 0.25 | 0.25 | 0.25 | 0.25 |
| Minerals | 0.25 | 0.2 | 0.1 | 0.25 | 0.25 | 0.25 | 0.25 | 0.25 |
| Supplemental fiber | | | | | | | | |
| Beet pulp | 2.0 | 6.0 | 4.0 | 0.0 | 4.0 | 6.0 | 0.0 | 2.0 |
| Fructo-oligosaccharide | 0.1 | 0.0 | 2.0 | 0.0 | 0.0 | 1.0 | 0.0 | 0.0 |
| Nut shell | | | | | | | | |
| Pecan nut shell | 0.1 | 0.0 | 2.0 | 86.0 | 30.0 | 55.0 | 15.0 | 0.0 |
| Pecan packing tissue | 0.01 | 0.0 | 0.2 | 9.0 | 1.5 | 5.5 | 5.0 | 0.0 |
| Walnut nut shell | 0.0 | 0.05 | 2.0 | 0.0 | 0.0 | 0.0 | 15.0 | 60.0 |
| Walnut packing tissue | 0.0 | 0.5 | 0.02 | 0.0 | 0.0 | 0.0 | 5.0 | 1.0 |

Moist animal food composition

| | Percentage on dry matter basis (w/w) | | | | | | |
|---|---|---|---|---|---|---|---|
| | Ex. 16 | Ex. 17 | Ex. 18 | Ex. 19 | Ex. 20 | Ex. 21 | Ex. 22 |
| Ingredient | | | | | | | |
| Poultry and fish products | 44.4 | 35.0 | 28.8 | 0.0 | 14.0 | 30.0 | 52.9 |
| Cereal grains | 19.5 | 30.0 | 45.0 | 2.0 | 10.0 | 19.96 | 19.5 |
| Humectants | 20.0 | 15 | 9.98 | 5.0 | 5.0 | 5.0 | 20.0 |
| Fat | 5.0 | 3.8 | 5.0 | 5.0 | 5.0 | 5.0 | 5.0 |
| Vitamins | 0.05 | 0.1 | 0.1 | 0.0 | 0.0 | 0.0 | 0.05 |
| Minerals | 0.05 | 0.1 | 0.1 | 0.0 | 0.0 | 0.0 | 0.05 |
| Supplemental fiber | | | | | | | |
| Beet pulp | 5.5 | 7.0 | 4.0 | 0.0 | 0.0 | 5.0 | 1.0 |
| Fructo-oligosaccharide | 0.0 | 1.9 | 2.0 | 0.0 | 0.0 | 0.01 | 1.0 |
| Nut shell | | | | | | | |
| Pecan nut shell | 0.0 | 7.0 | 2.5 | 80.0 | 0.0 | 35.0 | 0.5 |
| Pecan packing tissue | 0.0 | 0.1 | 0.0 | 8.0 | 0.0 | 0.03 | 0.0 |
| Walnut nut shell | 5.5 | 0.0 | 2.5 | 0.0 | 60.0 | 0.0 | 0.0 |
| Walnut packing tissue | 0.0 | 0.0 | 0.02 | 0.0 | 6.0 | 0.0 | 0.0 |

The dry animal food compositions of Examples 1, 2, 3, 4, 5, 6, and 7 can be made by first, milling and mixing the cereal grains with vitamins and minerals and supplemental fiber sources and nut shell. Then, add the cereal grains to the meat products and other protein sources. Extrude the ingredients into kibbles. Dry the kibbles. Package the finished product.

The wet animal food compositions of Examples 8, 9, 10, 11, 12, 13, 14, and 15 can be made by first drying and milling cereal grains. Mix dried cereal grains, vitamins, minerals and supplemental fiber sources and nut shell. Blend dry ingredients with meat products and other protein sources. The mixture is packaged into cans and cooked via retort process to provided finished product. For preformed pieces (chunks in gravy) mixture is extruded, passed through a steam tunnel for preconditioning, cut to desired shape, packaged with added water and retorted to provide safe finished product.

The moist animal food compositions of Examples 16, 17, 18, 19, 20, 21, and 22 can be made by milling and mixing the cereal grains with vitamins and minerals and supplemental fiber sources and nut shell. Then, add the cereal grains to the meat products and other protein sources with humectants to control water activity and mold. Extrude the ingredients into desired shape. Dry and package finished product.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed:

1. A process for controlling fecal hair excretion, controlling oral hair excretion and trichobezoar formation in an animal comprising; feeding an animal an animal food composition comprising a nut shell.

2. The process of claim 1, wherein said animal is selected from the group consisting of dog, cat, rabbit, guinea pig, hamster, gerbil, ferret, horses, zoo mammals.

3. The process of claim 1, comprising on a dry matter basis from about 0.01% of said nut shell to about 100% of said nut shell, by weight of the composition.

4. The process of claim 1, comprising on a dry matter basis from about 0.05% of said nut shell to about 50% of said nut shell, by weigh of the composition.

5. The process of claim 1, comprising on a dry matter basis from about 0.1% of said nut shell to about 30% of said nut shell, by weight of the composition.

6. The process of claim 1, comprising on a dry matter basis from about 0.2% of said nut shell to about 20% of said nut shell, by weight of the composition.

7. The process of claim 1, comprising on a dry matter basis from about 0.5% of said nut shell to about 10% of said nut shell, by weight of the composition.

8. The process of claim 1, wherein said nut shell is selected from the group consisting of pecan nut shell, walnut nut shell, filbert nut shell, hickory nut shell, hazelnut shell, chestnut nut shell, and combinations thereof.

9. The process of claim 8, wherein said nut shell is said pecan nut shell.

10. The process of claim 8, wherein said nut shell is a walnut nut shell.

11. The process of claim 1, wherein said composition is selected from the group consisting of wet compositions, moist compositions, dry compositions, and combinations thereof.

12. The process of claim 1, wherein said composition is selected from the group consisting of pet food, dog food, cat food, treats, chew, biscuits, gravy, sauce, beverage, supplemental water, and combinations thereof.

13. The process of claim 1, wherein said composition further comprising animal protein, plant protein, farinaceous matter, vegetables, fruit, egg-based materials, undenatured proteins, food grade polymeric adhesives, gels, polyols, starches, gums, flavorants, seasonings, salts, colorants, time-release compounds, minerals, vitamins, antioxidants, prebiotics, probiotics, aroma modifiers, and combinations thereof.

14. The process of claim 1, wherein said composition further comprising a supplemental fiber source.

15. The process of claim 1, further comprising a packing tissue.

16. A process for promoting satiety in an animal comprising; feeding an animal an animal food composition comprising a nut shell.

17. The process of claim 16, wherein said animal is selected from the group consisting of dog, cat, rabbit, guinea pig, hamster, gerbil, ferret, horses, zoo mammals.

18. The process of claim 16, comprising on a dry matter basis from about 0.01% of said nut shell to about 100% of said nut shell, by weight of the composition.

19. The process of claim 16, comprising on a dry matter basis from about 0.05% of said nut shell to about 50% of said nut shell, by weigh of the composition.

20. The process of claim 16, comprising on a dry matter basis from about 0.1% of said nut shell to about 30% of said nut shell, by weight of the composition.

21. The process of claim 16, comprising on a dry matter basis from about 0.2% of said nut shell to about 20% of said nut shell, by weight of the composition.

22. The process of claim 16, comprising on a dry matter basis from about 0.5% of said nut shell to about 10% of said nut shell, by weight of the composition.

23. The process of claim 16, wherein said nut shell is selected from the group consisting of pecan nut shell, walnut nut shell, filbert nut shell, hickory nut shell, hazelnut shell, chestnut nut shell, and combinations thereof.

24. The process of claim 23, wherein said nut shell is said pecan nut shell.

25. The process of claim 23, wherein said nut shell is a walnut nut shell.

26. The process of claim 16, wherein said composition is selected from the group consisting of wet compositions, moist compositions, dry compositions, and combinations thereof.

27. The process of claim 16, wherein said composition is selected from the group consisting of pet food, dog food, cat food, treats, chew, biscuits, gravy, sauce, beverage, supplemental water, and combinations thereof.

28. The process of claim 16, wherein said composition further comprising animal protein, plant protein, farinaceous matter, vegetables, fruit, egg-based materials, undenatured proteins, food grade polymeric adhesives, gels, polyols, starches, gums, flavorants, seasonings, salts, colorants, time-release compounds, minerals, vitamins, antioxidants, prebiotics, probiotics, aroma modifiers, and combinations thereof.

29. The process of claim 16, wherein said composition further comprising a supplemental fiber source.

30. The process of claim 16, further comprising a packing tissue.

31. A process for promoting healthy body weight in an animal comprising; feeding an animal an animal food composition comprising a nut shell.

32. The process of claim 31, wherein said animal is selected from the group consisting of dog, cat, rabbit, guinea pig, hamster, gerbil, ferret, horses, zoo mammals.

33. The process of claim 31, comprising on a dry matter basis from about 0.01% of said nut shell to about 100% of said nut shell, by weight of the composition.

34. The process of claim 31, comprising on a dry matter basis from about 0.05% of said nut shell to about 50% of said nut shell, by weigh of the composition.

35. The process of claim 31, comprising on a dry matter basis from about 0.1% of said nut shell to about 30% of said nut shell, by weight of the composition.

36. The process of claim 31, comprising on a dry matter basis from about 0.2% of said nut shell to about 20% of said nut shell, by weight of the composition.

37. The process of claim 31, comprising on a dry matter basis from about 0.5% of said nut shell to about 10% of said nut shell, by weight of the composition.

38. The process of claim 31, wherein said nut shell is selected from the group consisting of pecan nut shell, walnut nut shell, filbert nut shell, hickory nut shell, hazelnut shell, chestnut nut shell, and combinations thereof.

39. The process of claim 38, wherein said nut shell is said pecan nut shell.

40. The process of claim 38, wherein said nut shell is a walnut nut shell.

41. The process of claim 31, wherein said composition is selected from the group consisting of wet compositions, moist compositions, dry compositions, and combinations thereof.

42. The process of claim 31, wherein said composition is selected from the group consisting of pet food, dog food, cat food, treats, chew, biscuits, gravy, sauce, beverage, supplemental water, and combinations thereof.

43. The process of claim 31, wherein said composition further comprising animal protein, plant protein, farinaceous matter, vegetables, fruit, egg-based materials, undenatured proteins, food grade polymeric adhesives, gels, polyols, starches, gums, flavorants, seasonings, salts, colorants, time-release compounds, minerals, vitamins, antioxidants, prebiotics, probiotics, aroma modifiers, and combinations thereof.

44. The process of claim 31, wherein said composition further comprising a supplemental fiber source.

45. The process of claim 31, further comprising a packing tissue.
